(19) United States
(12) Patent Application Publication
(10) Pub. No.: US 2025/0358193 A1
(43) Pub. Date: Nov. 20, 2025

(54) ANOMALY DETECTION BASED ON METRIC MONITORING CRITICALITY AND METRIC INDEPENDENCE

(71) Applicant: ServiceNow, Inc., Santa Clara, CA (US)

(72) Inventors: Efrat Barkai, Givatayim (IL); Nir Arazy, Tel Aviv (IL)

(21) Appl. No.: 18/668,577

(22) Filed: May 20, 2024

(51) Int. Cl. H04L 41/142; H04L 41/16

(52) U.S. Cl. CPC H04L 41/142; H04L 41/16

(57) ABSTRACT

In the present application, improved techniques for anomaly detection are disclosed. A plurality of metric data streams is obtained. A first subset of the plurality of metric data streams is identified based on determining that each of the first subset of the plurality of metric data streams satisfies a monitoring criticality criterion. A second subset of the plurality of metric data streams is identified from the first subset of the plurality of metric data streams based on determining that each of the second subset of metric data streams satisfies a metric independence criterion. Anomaly detection is performed with respect to the second subset of the plurality of metric data streams.

### BACKGROUND OF THE INVENTION

Anomaly detection includes detecting a rare outlier or a data point outside of the trends of a set of data. Anomalies can be indicative of suspicious events, malfunctions, defects, or fraud. Anomaly detection may be used in various fields, including fraud detection, cybersecurity, network security, system health monitoring, industrial process monitoring, and the like. Anomaly detection offers several benefits. Anomaly detection enables organizations to proactively identify and address issues, improve decision-making, enhance security, and optimize operations, leading to increased efficiency, reliability, and customer satisfaction. Different techniques may be used for anomaly detection, including using a trained model with labeled data or unlabeled data.

However, these techniques are limited in terms of scalability. For example, anomaly detection becomes more challenging with large-scale or streaming data, where the volume, velocity, and variety of data are high. Scalability issues arise in terms of processing efficiency, memory requirements, and real-time responsiveness.

### BRIEF DESCRIPTION OF THE DRA WINGS

Various embodiments of the invention are disclosed in the following detailed description and the accompanying drawings.

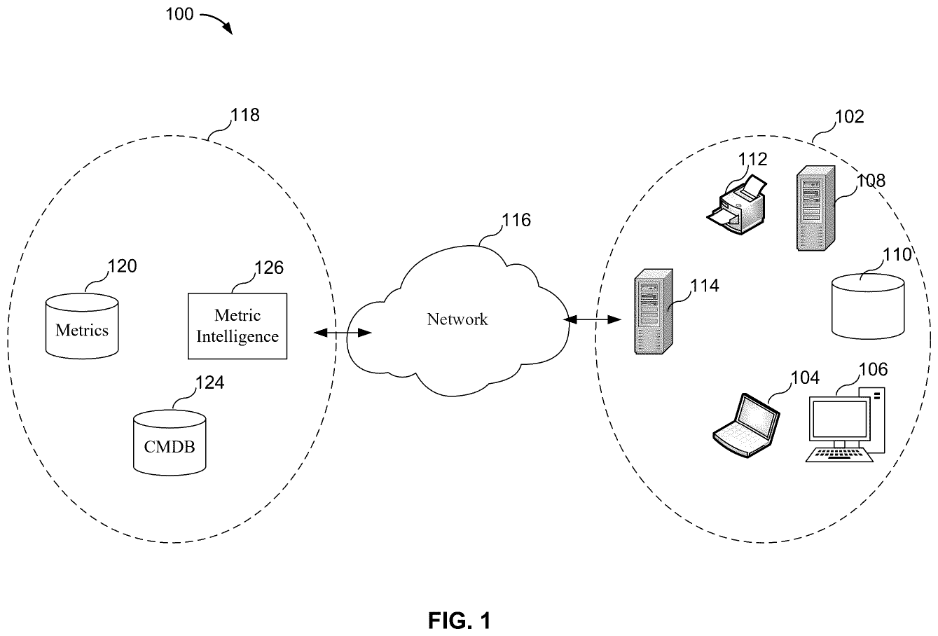

FIG. 1 illustrates an example of an information technology (IT) operations management (ITOM) system.

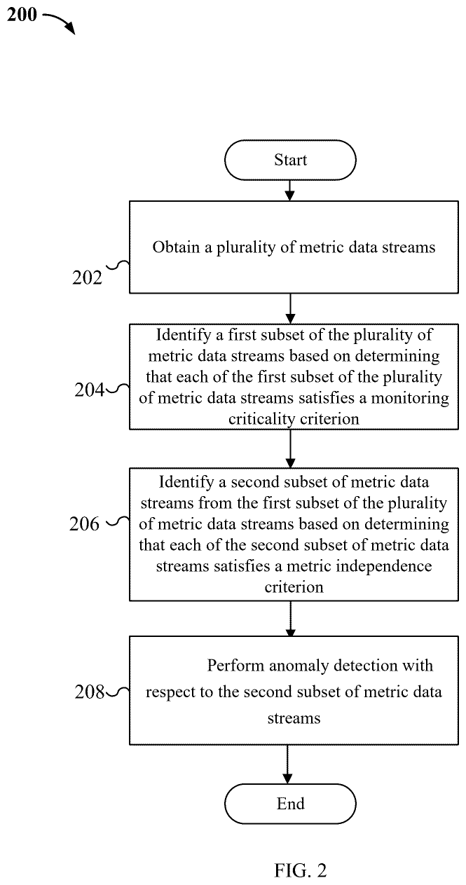

FIG. 2 illustrates an example of a process for filtering data streams, including data streams of metrics that are high volume or time-series data for anomaly detection.

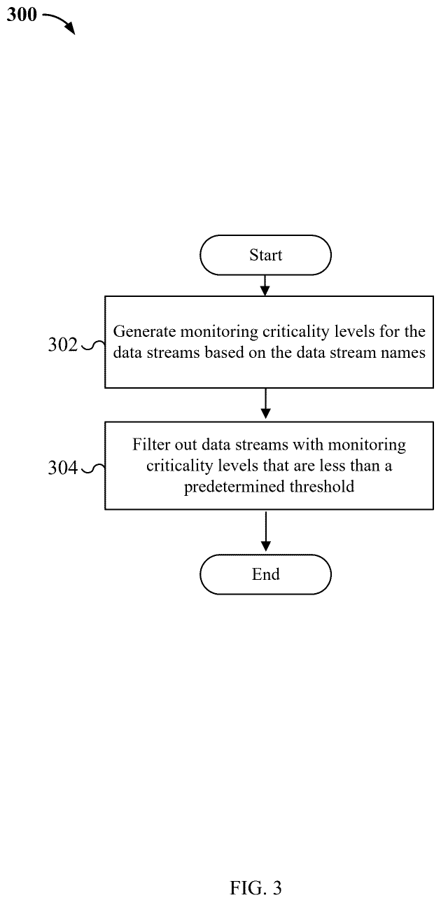

FIG. 3 illustrates an example of a process for filtering out unimportant data streams based on a predetermined threshold.

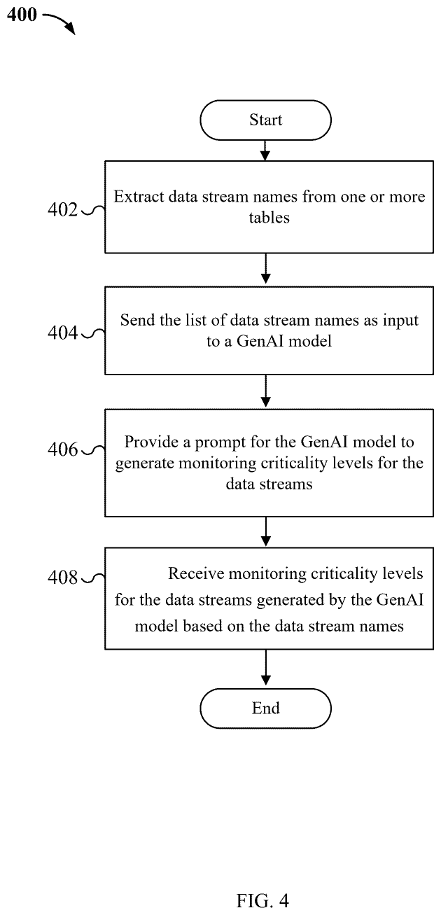

FIG. 4 illustrates an example of a process for generating monitoring criticality levels for the data streams based on the data stream names.

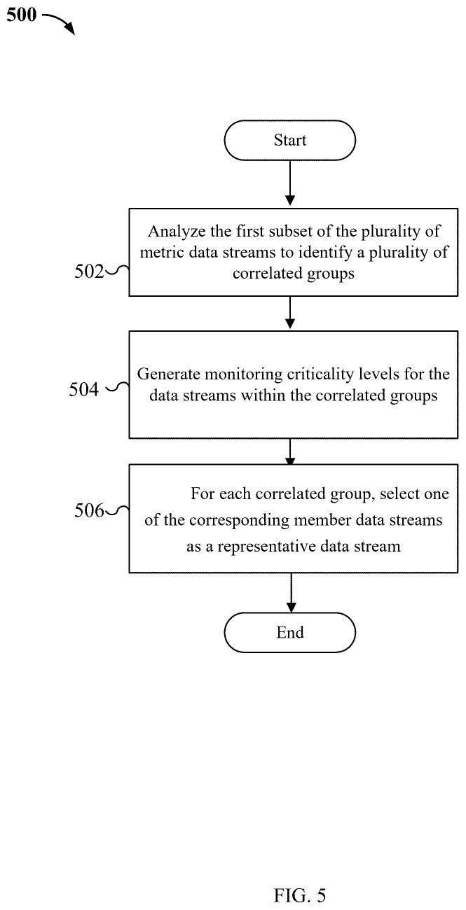

FIG. 5 illustrates an example of a process for identifying metric data streams for anomaly detection.

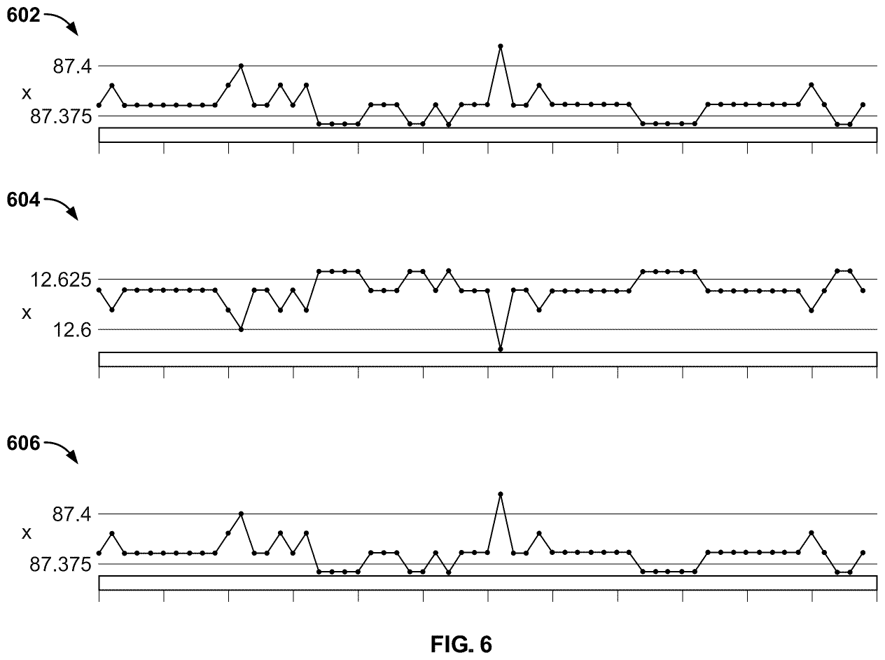

FIG. 6 illustrates example data streams that are correlated with one another.

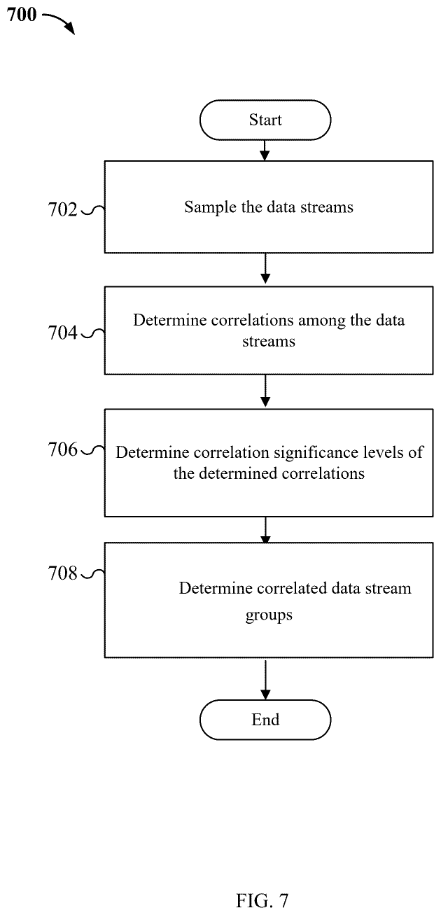

FIG. 7 illustrates an example of a process for determining correlated data stream groups.

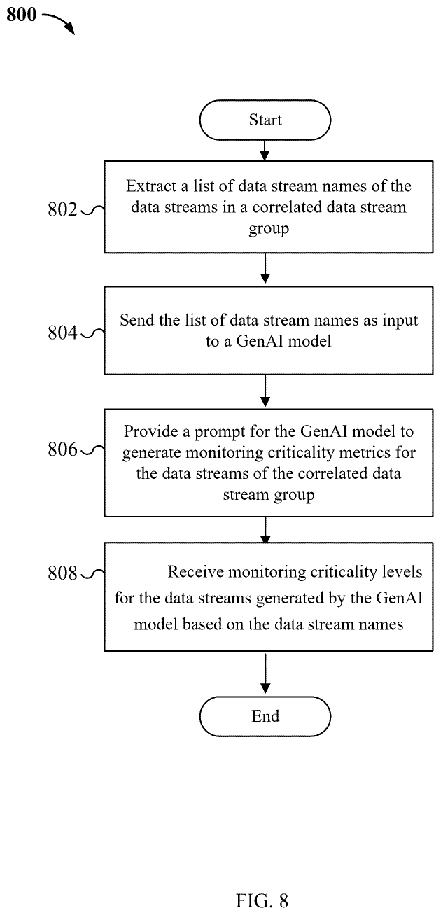

FIG. 8 illustrates an example of a process for generating the relative monitoring criticality levels for the data streams within the correlated data stream groups based on the data stream names.

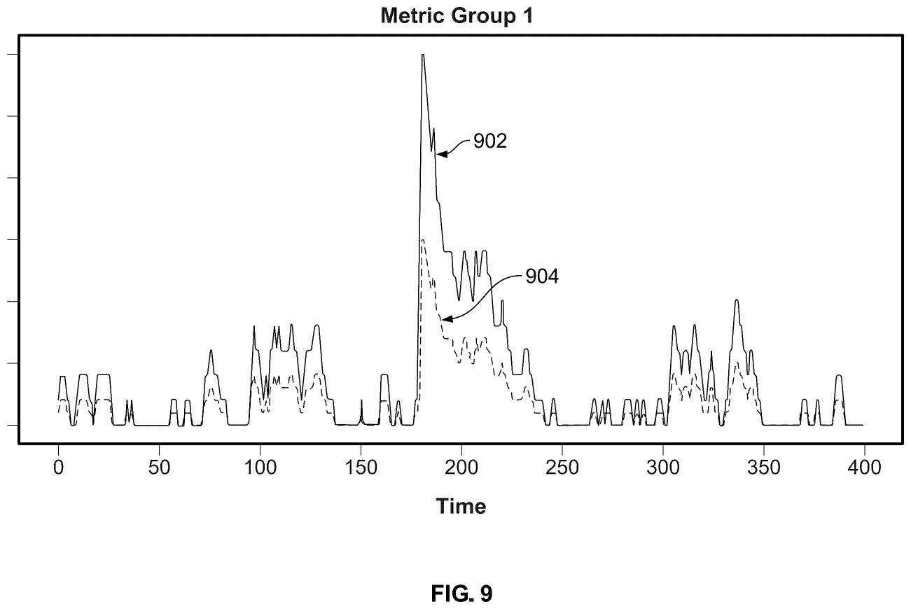

FIG. 9 illustrates one example of a correlated data stream group with two network metrics.

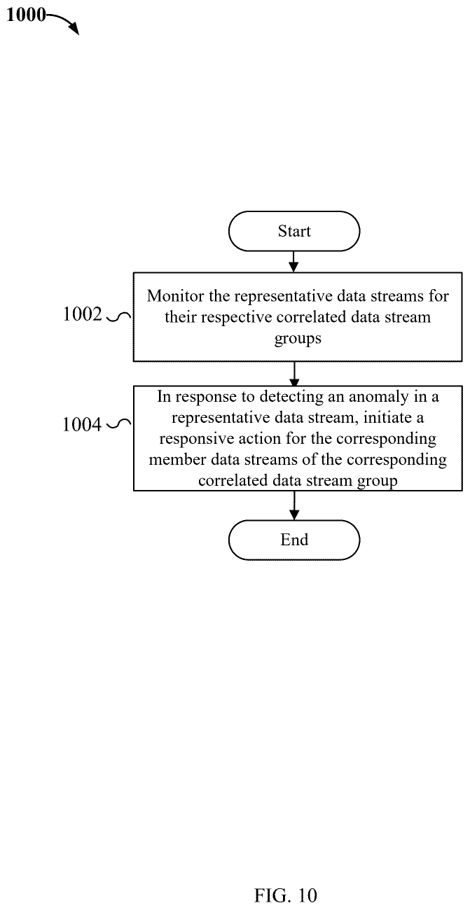

FIG. 10 illustrates an example of a process for performing anomaly detection of the second subset of metric data streams.

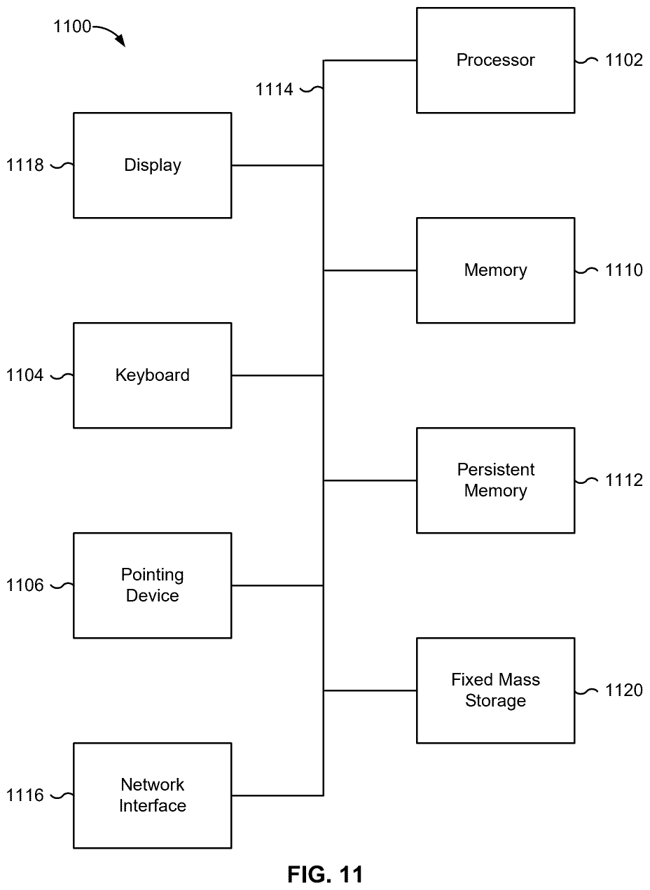

FIG. 11 is a functional diagram of a programmed computer system.

### DETAILED DESCRIPTION

Various implementation disclosed herein include a process; an apparatus; a system; a composition of matter; a computer program product embodied on a computer readable storage medium; and/or a processor, such as a processor configured to execute instructions stored on and/or provided by a memory coupled to the processor. In this specification, these implementations may be referred to as techniques. In general, the order of the steps of disclosed processes may be altered within the scope of the disclosure. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments is provided below along with accompanying figures that illustrate the principles of the embodiments. The disclosure is described in connection with such embodiments, but the disclosure is not limited to any embodiment. The scope of the embodiments is limited only by the claims and the disclosure encompasses numerous alternatives, modifications and equivalents. Numerous specific details are set forth in the following description in order to provide a thorough understanding of the disclosure. These details are provided for the purpose of example and the disclosure may be practiced according to the claims without some or all of these specific details. For the purpose of clarity, technical material that is known in the technical fields related to the disclosure has not been described in detail so that the disclosure is not unnecessarily obscured.

Information technology (IT) operations management (ITOM) is the management and strategic approach to planning, building, and operating digital services, technology, components, and application requirements in organizations. ITOM describes the individual processes and services that are administered by an IT department, including administrative processes, support for hardware and software, and services for internal and external clients. Effective ITOM ensures availability, performance, and efficiency within an organization's services and processes. ITOM defines the methods IT uses to manage services, support, and deployment to create consistency, quality of service, and reliability.

FIG. 1 illustrates an example of an ITOM system 100. ITOM system 100, including an instance 118, may be used to manage the operation of a corporate network 102. Corporate network 102 may include laptop computers 104, workstations 106, servers 108, databases 110, printers 112, and the like. Corporate network 102 may also include a server 114. A management, instrumentation, and discovery (MID) application (e.g., a Java application) may run on server 114 to facilitate communication and data movement between instance 118 of ITOM system 100 and the external applications, data sources, and services in corporate network 102 via a network 116. Network 116 may be any combination of public or private networks, including intranets, local area networks (LANs), wide area networks (WANs), radio access networks (RANs), Wi-Fi networks, the Internet, and the like.

Instance 118 includes various modules and components, including modules for discovery, event management, orchestration, service mapping, cloud management, operational intelligence, metric intelligence, and the like. Instance 118 further includes a configuration management database (CMDB) 124, which is a centralized file that functions as a comprehensive data warehouse, organizing information about an IT environment. CMDB clarifies the relationships between hardware, software components, and networks for improved configuration management. Configuration items (CIs) may include computers, devices, software, or services in the CMDB. A CI's record may include all of the relevant data, such as manufacturer, vendor, location, and the like.

A metric intelligence module 126 may be used to identify and prevent potential service outages. Metric intelligence module 126 indicates anomalous behavior of CIs based on historical metric data. Metric data from the source environment may be collected by various monitoring systems and stored in a metrics database 120. Metric intelligence module 126 captures the raw data from these monitoring systems, and uses event rules and the CMDB identification engine to map the data to existing CIs and their resources. The data is then analyzed to detect anomalies and to provide other statistical scores.

Metric intelligence module 126 uses historical metric data to build statistical models. These models facilitate projection of expected metric values along with upper and lower bounds. Metric intelligence module 126 then uses these projections to detect statistical outliers and to calculate anomaly scores. Anomalies may be scored on a range of, e.g., 0-10. High anomaly scores for CI metrics may indicate that a CI is at risk of causing a service outage. After processing, metric statistics and charts may be shown on a dashboard or other displays. Anomaly maps may display correlated scores for CIs with the highest anomaly scores, across a timeline.

Metric data includes time-series data. A time series is a series of data points in time order. The data points are measurements with timestamps. Time-series data includes data points recorded or measured over a series of discrete time intervals. Each data point may have two metrics: the time and date of when the data point was collected, and the value of that data point. Time-series data may be used in various fields, including finance, IoT (Internet of Things), monitoring systems, and scientific research. Examples of time-series data include weather records, economic indicators, patient health evolution metrics, server metrics, application performance monitoring metrics, network data, sensor data, events, clicks, and many other types of analytics data. Time-series anomalies can be used to detect active users, web page views, bounce rate, churn rate, average order value, mobile application installations, and the like.

Time-series anomaly detection poses additional challenges compared to traditional anomaly detection methods. Time-series data can accumulate rapidly, especially in large-scale systems or environments with high-frequency data collection. One of the key challenges is scalability. Scaling anomaly detection to monitor a large number of metrics in real-time or near-real-time poses scalability challenges in terms of processing efficiency, memory requirements, and computational overhead. A company (e.g., a telecom service provider) may face a significant challenge when millions of metrics need to be processed simultaneously. Streaming millions of time-series data points may create an overload, even before the anomaly detection process begins. Therefore, improved anomaly detection techniques are needed to handle the volume and velocity of time-series data and ensure timely detection of anomalies.

In the present application, improved techniques for anomaly detection are disclosed. One aspect of the disclosure includes a method for anomaly detection of metric data streams. A plurality of metric data streams is obtained. A first subset of the plurality of metric data streams is identified based on determining that each of the first subset of the plurality of metric data streams satisfies a monitoring criticality criterion. A second subset of metric data streams is identified from the first subset of the plurality of metric data streams based on determining that each of the second subset of metric data streams satisfies a metric independence criterion. Anomaly detection is performed with respect to the second subset of metric data streams.

Additional implementations of the disclosure may include one or more of the following optional features. The first subset of the plurality of metric data streams is analyzed to identify a plurality of correlated groups, wherein each of the correlated groups has one or more corresponding member metric data streams selected from the first subset of the plurality of metric data streams, and wherein corresponding member metric data streams of one correlated group satisfy the metric independence criterion with respect to corresponding member metric data streams of another correlated group. The second subset of metric data streams is identified by selecting one corresponding member metric data stream as a representative metric data stream for each correlated group. In response to detecting an anomaly in one representative metric data stream of a particular correlated group, a responsive action for corresponding member metric data streams of the particular correlated group is initiated. At least some of the first subset of the plurality of metric data streams are analyzed to identify at least some of the plurality of correlated groups during a predetermined sampling time window, wherein the predetermined sampling time window is selected to be a length sufficient for determining correlation. The predetermined sampling time window is further selected based on a type of the at least some of the first subset of the plurality of metric data streams, wherein the type of the at least some of the first subset of the plurality of metric data streams is one of the following: noisy time-series data, seasonal time-series data, or trendy time-series data. Identifying the plurality of correlated groups comprises determining correlation coefficients and significance levels. Selecting the one corresponding member metric data stream as the representative metric data stream for each correlated group comprises generating a plurality of relative monitoring criticality levels associated with corresponding member metric data streams using a generative artificial intelligence (GenAI) model based at least in part on metric data stream names as inputs to the GenAI model, wherein the plurality of relative monitoring criticality levels associated with the corresponding member metric data streams sum up to one. Selecting the one corresponding member metric data stream as the representative metric data stream for each correlated group comprises selecting one of the corresponding member metric data streams with a highest relative monitoring criticality level as the representative metric data stream. The plurality of relative monitoring criticality levels associated with the corresponding member metric data streams is generated using the GenAI model based at least in part on a prompt that specifies one or more of the following: a definition of a relative monitoring criticality level, a range of values of the relative monitoring criticality levels, or a business field to detect anomalies.

Additional implementations of the disclosure may include one or more of the following optional features. At least some of the plurality of metric data streams that do not satisfy the monitoring criticality criterion are filtered out based on a predetermined monitoring criticality threshold. A plurality of monitoring criticality levels associated with the at least some of the plurality of metric data streams that do not satisfy the monitoring criticality criterion are generated. At least some of the plurality of metric data streams that do not satisfy the monitoring criticality criterion are filtered out in response to determining that the plurality of monitoring criticality levels is each less than the predetermined monitoring criticality threshold. The plurality of monitoring criticality levels associated with the at least some of the plurality of metric data streams that do not satisfy the monitoring criticality criterion are generated using a generative artificial intelligence (GenAI) model based at least in part on metric data stream names as inputs to the GenAI model. The plurality of monitoring criticality levels associated with the at least some of the plurality of metric data streams that do not satisfy the monitoring criticality criterion are generated using the GenAI model based at least in part on a prompt that specifies one or more of the following: a definition of a monitoring criticality level, a range of values of the monitoring criticality levels, or a business field to detect anomalies.

Another aspect of the disclosure provides a system with one or more processors and a memory coupled to the one or more processors. The memory is configured to provide the one or more processors with instructions. When executed, the instructions cause the one or more processors to obtain a plurality of metric data streams; identify a first subset of the plurality of metric data streams based on determining that each of the first subset of the plurality of metric data streams satisfies a monitoring criticality criterion; identify a second subset of metric data streams from the first subset of the plurality of metric data streams based on determining that each of the second subset of metric data streams satisfies a metric independence criterion; and perform anomaly detection with respect to the second subset of metric data streams.

Another aspect of the disclosure provides a computer program product embodied in a non-transitory computer readable medium and comprising computer instructions for obtaining a plurality of metric data streams; identifying a first subset of the plurality of metric data streams based on determining that each of the first subset of the plurality of metric data streams satisfies a monitoring criticality criterion; identifying a second subset of metric data streams from the first subset of the plurality of metric data streams based on determining that each of the second subset of metric data streams satisfies a metric independence criterion; and performing anomaly detection with respect to the second subset of metric data streams.

The current disclosure is aimed at techniques for improving anomaly detection of metrics, including metrics that are time-series data. The improved techniques include intelligent filtering that operates before streaming and anomaly detection of time-series data. These improved techniques filter out metrics that can be excluded from the monitoring process, thereby substantially reducing the processing load. The filtering criteria include metrics that are not critical for monitoring, such as redundant or constant metrics, or metrics that are unrelated to system health. By grouping highly correlated metrics into correlated metric groups, only a single representative metric within each group needs to be streamed and monitored, further reducing the processing load.

In some embodiments, an integrated process leveraging machine learning (ML) and generative artificial intelligence (GenAI) is used to filter out or group metrics based on the metric names prior to streaming and detecting anomalies, thereby significantly reducing the number of metrics processed and monitored. The number of metrics monitored by anomaly detection for a specific CI may be significantly reduced (e.g., by 57%), thereby addressing scalability issues in terms of processing efficiency, memory requirements, and computational overhead.

FIG. 2 illustrates an example of a process 200 for filtering data streams, including data streams of metrics that are high volume or time-series data for anomaly detection. It should be recognized that metrics are merely one illustrative example of the different types of data streams that may be filtered by the improved techniques. In some embodiments, process 200 may be performed by at least instance 118 of ITOM system 100 in FIG. 1, including metric intelligence module 126 and other modules.

At 202, a plurality of metric data streams is obtained.

At 204, a first subset of the plurality of metric data streams is identified based on determining that each of the first subset of the plurality of metric data streams satisfies a monitoring criticality criterion. To identify these metric data streams that satisfy the monitoring criticality criterion, at least some of the plurality of metric data streams that do not satisfy the monitoring criticality criterion based on a predetermined monitoring criticality threshold are filtered out. In other words, metric data streams that are identified as unimportant based on a predetermined threshold are filtered out.

FIG. 3 illustrates an example of a process 300 for filtering out unimportant data streams based on a predetermined threshold. In some embodiments, process 300 is performed at 204 of process 200 in FIG. 2.

At 302, monitoring criticality levels (also referred to as importance factors) for the data streams are generated based on the data stream names. In some embodiments, the monitoring criticality levels are generated based on a generative artificial intelligence (GenAI) model. However, the monitoring criticality levels may be generated based on a rule-based model as well. A monitoring criticality level for a particular data stream indicates a level of criticality of the particular data stream being monitored for anomaly detection.

FIG. 4 illustrates an example of a process 400 for generating monitoring criticality levels for the data streams based on the data stream names. In some embodiments, process 400 is performed at step 302 of process 300 in FIG. 3.

At 402, a list of data stream names is extracted. In some embodiments, the list of data stream names is extracted from one or more database tables.

At 404, the list of data stream names is sent as input to a GenAI model. The input of the GenAI model refers to the entire sequence of text or tokens provided to the GenAI model for generating output.

At 406, a prompt for the GenAI model to generate monitoring criticality levels for the data streams is provided to the GenAI model. A prompt includes natural language text describing the task that the GenAI model should perform. A prompt is a specific type of input that provides some context or guidance to the model about what output to generate. The prompt may include phrases that define a monitoring criticality level, how the monitoring criticality level is being used, a set of criteria for evaluating certain metrics as important, and the like. For example, the prompt may include phrases such as “generate a monitoring criticality level that indicates whether the metric is important for monitoring the health of the ITOM system,” “important metrics are not constant over time,” “create a monitoring criticality level between zero and one, with zero being the least important and one being the most important,” and the like.

In some embodiments, the prompt may include additional information for increasing the accuracy of the GenAI model in determining the monitoring criticality levels for the data streams. The additional information may include the business field or industry to detect deviations or anomalies, such as cybersecurity, finance, healthcare, manufacturing, telecommunications, energy, supply chain management, environmental monitoring, marketing and e-commence, and the like.

At 408, monitoring criticality levels for the data streams that are generated by the GenAI model based on the data stream names are received. The GenAI model may be any trained model, such as the OpenAI's generative pre-trained transformer (GPT) model. The GenAI model may analyze the data stream names in the context of ITOM and the associated business field in order to generate the monitoring criticality levels of the data streams. For example, on a scale of zero to one, with zero being the least important and one being the most important, the GenAI model may generate a monitoring criticality level that ranges between zero and one for each data stream. The monitoring criticality level represents the importance level of monitoring a particular data stream for cost-effective and efficient anomaly detection.

The GenAI model may determine the monitoring criticality level based on different portions of the data stream names. Certain keywords in a data stream name may indicate that the data stream is likely a constant. For example, the keyword “central processing unit (CPU) core” in a data stream name may imply that the data stream value is constant and thus unimportant for monitoring purposes.

Referring back to process 300 of FIG. 3, at step 304, data streams with monitoring criticality levels that are less than a predetermined monitoring criticality level threshold are filtered out. To identify metric data streams that satisfy the monitoring criticality criterion, metric data streams that do not satisfy the monitoring criticality criterion based on a predetermined monitoring criticality threshold are filtered out. The data streams that are identified as unimportant for anomaly detection based on the monitoring criticality levels associated with the data streams and the predetermined monitoring criticality level threshold are filtered out. For example, data streams with monitoring criticality levels that are less than 0.5 in a scale of zero to one are filtered out.

For example, the metric name “timetaken_stddev” has a low monitoring criticality level of 0.4 and is filtered out. The monitoring criticality level model may determine that a standard deviation (stddev) of the time taken (timetaken) is valuable for performance analysis but may not be as crucial as other metrics. In another example, the metric name “1_minute_rate” has a low monitoring criticality level of 0.4 and is filtered out. The monitoring criticality level model may determine that a one-minute rate (1_minute_rate) may be important for specific use cases but may not be as critical in general. In another example, the metric name “cache.keys.size” has a low monitoring criticality level of 0.3 and is filtered out. The monitoring criticality level model may determine that the size of cache keys (cache.keys.size) may be less critical for general anomaly detection. In another example, the metric name “count” has a low monitoring criticality level of 0.2 and is filtered out. The monitoring criticality level model may determine that the count metric may be important for specific use cases but is generally less crucial for anomaly detection. In yet another example, the metric name “size” has a low monitoring criticality level of 0.2 and is filtered out. The monitoring criticality level model may determine that the size metric may be important for specific use cases but is generally less crucial for anomaly detection. In another example, the metric name “storage_limit” has a medium monitoring criticality level of 0.6 and is not filtered out. The monitoring criticality level model may determine that a storage limit (storage_limit) is important but may not change significantly over short time frames.

Automatically filtering out the metrics with monitoring criticality levels that are less than a predetermined threshold is advantageous because metrics that are known to be substantially constant or do not reflect the health of the ITOM system are automatically filtered out with minimal waste of time, resources, or effort, thereby eliminating the need for a system administrator to manually remove the metrics from a list of metrics to be monitored for anomaly detection. Furthermore, it eliminates the need to stream the unimportant metrics that do not reflect the health of the ITOM system.

Referring back to process 200 of FIG. 2, at 206, a second subset of metric data streams is identified from the first subset of the plurality of metric data streams based on determining that each of the second subset of metric data streams satisfies a metric independence criterion. In some embodiments, the metric independence criterion requires that two metric data streams within this second subset of metric data streams are not correlated within a predetermined threshold, as will be described in greater detail below.

FIG. 5 illustrates an example of a process 500 for identifying metric data streams for anomaly detection. In some embodiments, process 500 is performed at step 206 of process 200 in FIG. 2.

At 502, the first subset of the plurality of metric data streams is analyzed to identify a plurality of correlated groups, wherein each of the correlated groups has one or more corresponding member metric data streams selected from the first subset of the plurality of metric data streams, and wherein corresponding member metric data streams of one correlated group satisfy the metric independence criterion with respect to corresponding member metric data streams of another correlated group. The first subset of the plurality of metric data streams is the remaining data streams after the unimportant data streams have been filtered out at step 204 of process 200 in FIG. 2 or step 304 of process 300 in FIG. 3.

Data streams that are correlated with one another are determined and grouped together. In other words, data streams that are not within the same group are relatively independent from each other. FIG. 6 illustrates example data streams that are correlated with one another. Data stream 602 and data stream 604 are substantially equal to a mirror reflection of one another. Data stream 602 and data stream 606 are substantially identical with one another.

Two correlated time series refer to a pair of datasets where the values of each dataset vary over time and there exists a statistical relationship between their respective values at different time points. In other words, the values of one time series are systematically related to the values of the other time series. Correlation between two time-series implies that changes in one series are associated with changes in the other series. These changes may occur simultaneously or with a lag. Two correlated time series may move in the same direction (e.g., rise or fall) over time. Correlation between time series may be measured using statistical or machine learning techniques, including Pearson correlation coefficient, Spearman rank correlation coefficient, autocorrelation analysis, propensity score, dimensionality reduction, and the like.

FIG. 7 illustrates an example of a process 700 for determining correlated data stream groups. In some embodiments, process 700 is performed at 502 of process 500 in FIG. 5.

At 702, the data streams are sampled and analyzed. For example, the sampled data streams may include the remaining data streams after the data streams that are identified as unimportant based on the predetermined threshold have been filtered out at step 204 of process 200 in FIG. 2 or step 304 of process 300 in FIG. 3. Sampling data refers to the process of selecting a subset of data points or observations from a larger dataset in order to analyze or make inferences about the entire population from which the data was collected. In some embodiments, different metrics corresponding to each configurable item (CI) may be sampled. In some embodiments, a particular metric is sampled and analyzed within a predetermined time window. In some embodiments, the predetermined time window is selected to be the time window needed to sample and analyze two data streams in order to determine their correlation, which depends on different factors, including the frequency of sampling, the type of time-series data, whether the two data streams exhibit strong patterns or trends, the expected lag between the two data streams, the strength of correlation, the choice of statistical method used for determining correlation, and the like. For example, there are different types of time-series data, including noisy, seasonal, or trendy time-series data, and each may have a different optimal time window for determining correlation among different data streams, which may be optimized by an external or offline analysis.

Sampling of a data stream includes streaming the data stream at least during the predetermined sampling time window. The predetermined sampling time window is typically substantially shorter than the time window needed for anomaly detection, thereby significantly reducing the amount of data that is streamed. For example, noisy time-series data requires only a short sampling time window to determine correlation among different data streams, especially when two data streams are grouped together as a correlated data stream group only if the two data streams are almost completely correlated (e.g., with a correlation coefficient above 0.95). Seasonal time-series data may require a longer sampling time window to determine correlation among different data streams, but it is still significantly shorter than the time window needed for anomaly detection (e.g., up to a week).

At 704, correlations among the sampled data streams are determined. Correlation among the data streams may be measured using statistical or machine learning techniques, including Pearson correlation coefficient, Spearman rank correlation coefficient, autocorrelation analysis, propensity score, dimensionality reduction, and the like. Determining the correlation between two data streams includes calculating the correlation coefficient between the two data streams, which quantifies the strength and direction of the linear relationship between them. A correlation coefficient close to +1 indicates a strong positive relationship, while a correlation coefficient close to −1 indicates a strong negative relationship. A coefficient close to 0 suggests a weak or no linear relationship.

At 706, correlation significance levels of the determined correlations are determined. Correlation significance assesses whether an observed correlation coefficient is statistically significant or likely due to chance. It includes calculating a p-value, which indicates the probability of observing a correlation coefficient as extreme as, or more extreme than, the one computed from the data, assuming the null hypothesis (no correlation) is true. If the p-value is less than a predetermined significance level (e.g., 0.05), the correlation coefficient is considered statistically significant. A significant correlation coefficient suggests that the observed relationship between the variables is unlikely to be due to random chance. For example, a correlation coefficient of +0.95 with a p-value of 0.001 indicates a strong positive relationship that is statistically significant. This suggests that the observed relationship between the variables is unlikely to have occurred by chance alone.

At 708, correlated data stream groups are determined. Two data streams are grouped together as belonging to the same correlated data stream group if the correlation coefficient and the correlation significance both satisfy their respective predetermined required thresholds. In some embodiments, the predetermined correlation coefficient threshold is above +0.95 or below −0.95, and the predetermined correlation significance level is below 0.05. For example, referring back to FIG. 6, data stream 602 and data stream 604 are substantially equal to a mirror reflection of one another, and the two data streams have a correlation coefficient that is below −0.95 and a correlation significance level that is below 0.05, and therefore the two data streams 602 and 604 may be grouped together as belonging to the same correlated data stream group. Data stream 602 and data stream 606 are substantially identical with one another, and the two data streams have a correlation coefficient that is above +0.95 and a correlation significance level that is below 0.05, and therefore the two data streams 602 and 606 may be grouped together as belonging to the same correlated data stream group.

The advantage of determining that two data streams belong to the same correlated data stream group is that it eliminates the need to stream and detect any anomalies within both data streams. This is because if an anomaly occurred on one data stream within a correlated data stream group, then there is a high probability that an anomaly would occur on the other data streams in the same group. Therefore, only one of the data streams needs to be monitored. As a result, the number of metrics that are processed and monitored are significantly reduced, thereby solving scalability issues in terms of processing efficiency, memory requirements, and computational overhead.

Referring back to process 500 of FIG. 5, at 504, relative monitoring criticality levels for the data streams within a correlated data stream group are generated. In some embodiments, the relative monitoring criticality levels are generated based on a generative artificial intelligence (GenAI) model. However, the relative monitoring criticality levels may be generated based on a rule-based model as well.

FIG. 8 illustrates an example of a process 800 for generating the relative monitoring criticality levels for the data streams within the correlated data stream groups based on the data stream names. In some embodiments, process 800 is performed at step 504 of process 500 in FIG. 5.

At 802, for a given correlated data stream group, a list of data stream names of the data streams in the correlated data stream group is extracted.

At 804, the list of data stream names of the data streams in the correlated data stream group is sent as input to a GenAI model. The input of the GenAI model refers to the entire sequence of text or tokens provided to the GenAI model for generating output.

At 806, a prompt for the GenAI model to generate the relative monitoring criticality levels for the data streams is provided to the GenAI model. A prompt includes natural language text describing the task that the GenAI model should perform. A prompt is a specific type of input that provides some context or guidance to the model about what output to generate. The prompt may include phrases that define a monitoring criticality level, how the monitoring criticality level is being used, a set of criteria for evaluating certain metrics as important, and the like. For example, the prompt may include phrases “generate a monitoring criticality level that indicates whether the metric is important for monitoring the health of the ITOM system,” “important metrics are not constant over time,” “create a monitoring criticality level between zero and one, with zero being the least important and one being the most important,” and the like. In some embodiments, the relative monitoring criticality levels of all the data streams within a correlated data stream group should sum up to a value of one. And the prompt may include a phrase such as “the relative monitoring criticality levels of all the metrics in the correlated data stream group should sum up to one.”

In some embodiments, the prompt may include additional information for increasing the accuracy of the GenAI model in determining the relative monitoring criticality levels for the data streams. The additional information may include the business field or industry to detect deviations or anomalies, such as cybersecurity, finance, healthcare, manufacturing, telecommunications, energy, supply chain management, environmental monitoring, marketing and e-commence, and the like.

At 808, the relative monitoring criticality levels for the data streams that are generated by the GenAI model based on the data stream names are received. The GenAI model may be any trained model, such as the OpenAI's generative pre-trained transformer (GPT) model. The GenAI model may analyze the data stream names in the context of ITOM and the business field in order to generate the relative monitoring criticality levels of the data streams. For example, on a scale of zero to one, with zero being the least important and one being the most important, the GenAI model may generate a monitoring criticality level that ranges between zero and one for each data stream. The relative monitoring criticality levels of all the data streams within a correlated data stream group should sum up to a value of one. The relative monitoring criticality level represents the importance level of monitoring a particular data stream for cost-effective and efficient anomaly detection.

The GenAI model may determine the monitoring criticality level based on different portions of the data stream names. Certain keywords in a data stream name may indicate that monitoring the particular data stream is more important for anomaly detection than other data streams within the correlated data stream group.

Referring back to process 500 of FIG. 5, at step 506, for each correlated data stream group, one of the corresponding member data streams is selected as a representative data stream. For example, the data streams with the highest relative monitoring criticality levels within their respective correlated data stream groups are selected. These selected data streams form the second subset of metric data streams that are identified at step 206 of process 200 in FIG. 2.

FIG. 9 illustrates one example of a correlated data stream group with two network metrics 902 and 904. Network metric 902 has a metric name “system.network.Packets/sec (Average)” and network metric 904 has a metric name “system.network.Packets_Sent_Unicast/sec (Average).” The correlation coefficient of the two metrics is 0.83. The monitoring criticality level of network metric 902 is 0.58 (58%), while the monitoring criticality level of network metric 904 is 0.42 (42%). The relative monitoring criticality levels of the two network metrics within the correlated data stream group sum up to one. If the predetermined correlation coefficient threshold (see step 708 of process 700 in FIG. 7) is configured as above +0.8 or below −0.8, then network metrics 902 and 904 may be grouped into one correlated data stream group. Since network metric 902 has the highest monitoring criticality level within the correlated data stream group, network metric 902 is selected as a metric representing the entire correlated data stream group.

Another example of a correlated data stream group includes three different memory metrics. The memory metric names are “memory_percent.freeWOBuffersCaches,” “memory_percent.usedWOBuffersCaches,” and “memory_percent.available,” with relative monitoring criticality levels of 0.36, 0.41, and 0.23, respectively. The correlation coefficient of the three metrics is 0.91. The relative monitoring criticality levels of the three different memory metrics within the correlated data stream group sum up to one. Since memory metric “memory_percent.usedWOBuffersCaches” has the highest monitoring criticality level within the correlated data stream group, it is selected as a metric representing the entire correlated data stream group.

Another example of a correlated data stream group includes two different CPU metrics. The memory metric names are “cpu.idle_percentage (Raw),” and “cpu.avgutilization_percentage (Raw),” with relative monitoring criticality levels of 0.49 and 0.51, respectively. The correlation coefficient of the two metrics is 0.67. The relative monitoring criticality levels of the two different memory metrics within the correlated data stream group sum up to one. Since memory metric “cpu.avgutilization_percentage (Raw)” has the highest monitoring criticality level within the correlated data stream group, it is selected as a metric representing the entire correlated data stream group.

Referring back to process 200 in FIG. 2, at step 208, anomaly detection is performed with respect to the second subset of metric data streams.

FIG. 10 illustrates an example of a process 1000 for performing anomaly detection of the second subset of metric data streams. In some embodiments, process 1000 is performed at step 208 of process 200 in FIG. 2.

At step 1002, the representative data streams for their respective correlated data stream groups are monitored. The selected data streams with the highest relative monitoring criticality levels within their respective correlated data stream groups are streamed and monitored for anomaly detection. The data streams within a correlated data stream group that are not selected are filtered out such that they are not streamed or being monitored individually for anomaly detection.

The advantage of streaming and monitoring only the data stream with the highest monitoring criticality level within a correlated data stream group is that it eliminates the need to stream and detect any anomalies within the other data streams within the group. As a result, the number of metrics that are processed and monitored is significantly reduced, thereby solving scalability issues in terms of processing efficiency, memory requirements, and computational overhead.

At step 1004, in response to detecting an anomaly in a representative data stream, a responsive action for the corresponding member data streams of the corresponding correlated data stream group is initiated. In other words, the representative data stream and other data streams that belong to the same correlated data stream group are examined.

In some embodiments, if an anomaly is detected within an anomaly time period of the detected data stream, then all the data streams within the correlated data stream group within the anomaly time period are examined. An alert may be generated to indicate to the system administrator that an anomaly has been detected in the correlated data stream group, and the alert may further display the metrics that belong to the group. In some embodiments, if an anomaly is detected within an anomaly time period of the detected data stream, then the detected data stream within the anomaly time period is examined. In addition, an alert may be generated to recommend that the other data streams within the same correlated data stream group should be further examined.

FIG. 11 is a functional diagram of a programmed computer system. In some embodiments, at least parts of system 100 in FIG. 1 are executed by computer system 1100. Computer system 1100 is an example of a processor.

In the example shown, computer system 1100 includes various subsystems as described below. Computer system 1100 includes at least one microprocessor subsystem (also referred to as a processor or a central processing unit (CPU)) 1102. Computer system 1100 can be physical or virtual (e.g., a virtual machine). For example, processor 1102 can be implemented by a single-chip processor or by multiple processors. In some embodiments, processor 1102 is a general-purpose digital processor that controls the operation of computer system 1100. Using instructions retrieved from memory 1110, processor 1102 controls the reception and manipulation of input data, and the output and display of data on output devices (e.g., display 1118).

Processor 1102 is coupled bi-directionally with memory 1110, which can include a first primary storage, typically a random-access memory (RAM), and a second primary storage area, typically a read-only memory (ROM). As is well known in the art, primary storage can be used as a general storage area and as scratch-pad memory, and can also be used to store input data and processed data. Primary storage can also store programming instructions and data, in the form of data objects and text objects, in addition to other data and instructions for processes operating on processor 1102. Also, as is well known in the art, primary storage typically includes basic operating instructions, program code, data, and objects used by the processor 1102 to perform its functions (e.g., programmed instructions). For example, memory 1110 can include any suitable computer-readable storage media, described below, depending on whether, for example, data access needs to be bi-directional or uni-directional. For example, processor 1102 can also directly and very rapidly retrieve and store frequently needed data in a cache memory (not shown).

Persistent memory 1112 (e.g., a removable mass storage device) provides additional data storage capacity for computer system 1100, and is coupled either bi-directionally (read/write) or uni-directionally (read only) to processor 1102. For example, persistent memory 1112 can also include computer-readable media such as magnetic tape, flash memory, PC-CARDS, portable mass storage devices, holographic storage devices, and other storage devices. A fixed mass storage 1120 can also, for example, provide additional data storage capacity. The most common example of fixed mass storage 1120 is a hard disk drive. Persistent memory 1112 and fixed mass storage 1120 generally store additional programming instructions, data, and the like that typically are not in active use by the processor 1102. It will be appreciated that the information retained within persistent memory 1112 and fixed mass storages 1120 can be incorporated, if needed, in standard fashion as part of memory 1110 (e.g., RAM) as virtual memory.

In addition to providing processor 1102 access to storage subsystems, bus 1114 can also be used to provide access to other subsystems and devices. As shown, these can include a display monitor 1118, a network interface 1116, a keyboard 1104, and a pointing device 1106, as well as an auxiliary input/output device interface, a sound card, speakers, and other subsystems as needed. For example, pointing device 1106 can be a mouse, stylus, track ball, or tablet, and is useful for interacting with a graphical user interface.

Network interface 1116 allows processor 1102 to be coupled to another computer, computer network, or telecommunications network using a network connection as shown. For example, through network interface 1116, processor 1102 can receive information (e.g., data objects or program instructions) from another network or output information to another network in the course of performing method/process steps. Information, often represented as a sequence of instructions to be executed on a processor, can be received from and outputted to another network. An interface card or similar device and appropriate software implemented by (e.g., executed/performed on) processor 1102 can be used to connect computer system 1100 to an external network and transfer data according to standard protocols. Processes can be executed on processor 1102, or can be performed across a network such as the Internet, intranet networks, or local area networks, in conjunction with a remote processor that shares a portion of the processing. Additional mass storage devices (not shown) can also be connected to processor 1102 through network interface 1116.

An auxiliary I/O device interface (not shown) can be used in conjunction with computer system 1100. The auxiliary I/O device interface can include general and customized interfaces that allow processor 1102 to send and, more typically, receive data from other devices such as microphones, touch-sensitive displays, transducer card readers, tape readers, voice or handwriting recognizers, biometrics readers, cameras, portable mass storage devices, and other computers.

In addition, various embodiments disclosed herein further relate to computer storage products with a computer readable medium that includes program code for performing various computer-implemented operations. The computer-readable medium is any data storage device that can store data which can thereafter be read by a computer system. Examples of computer-readable media include, but are not limited to, all the media mentioned above: magnetic media such as hard disks, floppy disks, and magnetic tape; optical media such as CD-ROM disks; magneto-optical media such as optical disks; and specially configured hardware devices such as application-specific integrated circuits (ASICs), programmable logic devices (PLDs), and ROM and RAM devices. Examples of program code include both machine code, as produced, for example, by a compiler, or files containing higher level code (e.g., script) that can be executed using an interpreter.

The computer system shown in FIG. 11 is but an example of a computer system suitable for use with the various embodiments disclosed herein. Other computer systems suitable for such use can include additional or fewer subsystems. In addition, bus 1114 is illustrative of any interconnection scheme serving to link the subsystems. Other computer architectures having different configurations of subsystems can also be utilized.

Although the foregoing embodiments have been described in some detail for purposes of clarity of understanding, the disclosure is not limited to the details provided. There are many alternative ways of implementing the disclosure. The disclosed embodiments are illustrative and not restrictive.

What is claimed is:

1. A method comprising:
obtaining a plurality of metric data streams;
identifying a first subset of the plurality of metric data streams based on determining that each of the first subset of the plurality of metric data streams satisfies a monitoring criticality criterion;
identifying a second subset of the plurality of metric data streams from the first subset of the plurality of metric data streams based on determining that each of the second subset of the plurality of metric data streams satisfies a metric independence criterion; and
performing anomaly detection with respect to the second subset of the plurality of metric data streams.

2. The method of claim 1, further comprising, analyzing the first subset of the plurality of metric data streams to identify a plurality of correlated groups, wherein each of the correlated groups has one or more corresponding member metric data streams selected from the first subset of the plurality of metric data streams, and wherein corresponding member metric data streams of one correlated group satisfies the metric independence criterion with respect to corresponding member metric data streams of another correlated group, wherein identifying the second subset of the plurality of metric data streams includes selecting one corresponding member metric data stream as a representative metric data stream for each correlated group.

3. The method of claim 2, further comprising:
in response to detecting an anomaly in one representative metric data stream of a particular correlated group, initiating a responsive action for corresponding member metric data streams of the particular correlated group.

4. The method of claim 2, further comprising:
analyzing at least some of the first subset of the plurality of metric data streams to identify at least some of the plurality of correlated groups during a predetermined sampling time window, wherein the predetermined sampling time window is selected to be a length sufficient for determining correlation.

5. The method of claim 4, wherein the predetermined sampling time window is further selected based on a type of the at least some of the first subset of the plurality of metric data streams, wherein the type of the at least some of the first subset of the plurality of metric data streams is one of the following: noisy time-series data, seasonal time-series data, or trendy time-series data.

6. The method of claim 2, wherein identifying the plurality of correlated groups comprises:
determining correlation coefficients and significance levels.

7. The method of claim 2, wherein selecting the one corresponding member metric data stream as the representative metric data stream for each correlated group comprises:
generating a plurality of relative monitoring criticality levels associated with corresponding member metric data streams using a generative artificial intelligence (GenAI) model based at least in part on metric data stream names as inputs to the GenAI model, wherein the plurality of relative monitoring criticality levels associated with the corresponding member metric data streams sum up to one; and
selecting one of the corresponding member metric data streams with a highest relative monitoring criticality level as the representative metric data stream.

8. The method of claim 7, further comprising:
generating the plurality of relative monitoring criticality levels associated with the corresponding member metric data streams using the GenAI model based at least in part on a prompt that specifies one or more of the following: a definition of a relative monitoring criticality level, a range of values of the relative monitoring criticality levels, or a business field to detect anomalies.

9. The method of claim 1, further comprising:
filtering out at least some of the plurality of metric data streams that do not satisfy the monitoring criticality criterion based on a predetermined monitoring criticality threshold.

10. The method of claim 9, further comprising:
generating a plurality of monitoring criticality levels associated with the at least some of the plurality of metric data streams that do not satisfy the monitoring criticality criterion; and
filtering out the at least some of the plurality of metric data streams that do not satisfy the monitoring criticality criterion in response to determining that the plurality of monitoring criticality levels is each less than the predetermined monitoring criticality threshold.

11. The method of claim 10, further comprising:
generating the plurality of monitoring criticality levels associated with the at least some of the plurality of metric data streams that do not satisfy the monitoring criticality criterion using a generative artificial intelligence (GenAI) model based at least in part on metric data stream names as inputs to the GenAI model.

12. The method of claim 11, further comprising:
generating the plurality of monitoring criticality levels associated with the at least some of the plurality of metric data streams that do not satisfy the monitoring criticality criterion using the GenAI model based at least in part on a prompt that specifies one or more of the following: a definition of a monitoring criticality level, a range of values of the monitoring criticality levels, or a business field to detect anomalies.

13. A system comprising:
a processor configured to:
obtain a plurality of metric data streams;
identify a first subset of the plurality of metric data streams based on determining that each of the first subset of the plurality of metric data streams satisfies a monitoring criticality criterion;
identify a second subset of the plurality of metric data streams from the first subset of the plurality of metric data streams based on determining that each of the second subset of the plurality of metric data streams satisfies a metric independence criterion; and
perform anomaly detection with respect to the second subset of the plurality of metric data streams; and
a memory coupled to the processor and configured to provide the processor with instructions.

14. The system of claim 13, wherein the processor is further configured to:
analyze the first subset of the plurality of metric data streams to identify a plurality of correlated groups, wherein each of the correlated groups has one or more corresponding member metric data streams selected from the first subset of the plurality of metric data streams, and wherein corresponding member metric data streams of one correlated group satisfies the metric independence criterion with respect to corresponding member metric data streams of another correlated group; and
identify the second subset of the plurality of metric data streams by selecting one corresponding member metric data stream as a representative metric data stream for each correlated group.

15. The system of claim 14, wherein the processor is further configured to:
in response to detecting an anomaly in one representative metric data stream of a particular correlated group, initiate a responsive action for corresponding member metric data streams of the particular correlated group.

16. The system of claim 14, wherein selecting the one corresponding member metric data stream as the representative metric data stream for each correlated group comprises to:
generate a plurality of relative monitoring criticality levels associated with corresponding member metric data streams using a generative artificial intelligence (GenAI) model based at least in part on metric data stream names as inputs to the GenAI model, wherein the plurality of relative monitoring criticality levels associated with the corresponding member metric data streams sum up to one; and
select one of the corresponding member metric data streams with a highest relative monitoring criticality level as the representative metric data stream.

17. The system of claim 13, wherein the processor is further configured to:
filter out at least some of the plurality of metric data streams that do not satisfy the monitoring criticality criterion based on a predetermined monitoring criticality threshold.

18. The system of claim 17, wherein the processor is further configured to:
generate a plurality of monitoring criticality levels associated with the at least some of the plurality of metric data streams that do not satisfy the monitoring criticality criterion; and
filter out the at least some of the plurality of metric data streams that do not satisfy the monitoring criticality criterion in response to determining that the plurality of monitoring criticality levels is each less than the predetermined monitoring criticality threshold.

19. The system of claim 18, wherein the processor is further configured to:
generate the plurality of monitoring criticality levels associated with the at least some of the plurality of metric data streams that do not satisfy the monitoring criticality criterion using a generative artificial intelligence (GenAI) model based at least in part on metric data stream names as inputs to the GenAI model.

20. A computer program product embodied in a non-transitory computer readable medium and comprising computer instructions for:
obtaining a plurality of metric data streams;
identifying a first subset of the plurality of metric data streams based on determining that each of the first subset of the plurality of metric data streams satisfies a monitoring criticality criterion;
identifying a second subset of the plurality of metric data streams from the first subset of the plurality of metric data streams based on determining that each of the second subset of the plurality of metric data streams satisfies a metric independence criterion; and
performing anomaly detection with respect to the second subset of the plurality of metric data streams.
